(19) United States
(12) Patent Application Publication
(10) Pub. No.: US 2007/0200913 A1
(43) Pub. Date: Aug. 30, 2007

(54) Method for entering, archiving, consulting, and transmitting a document to an addressee by means of a camera

(76) Inventors: Martin Lefebure, Courbevoie (FR); Antoine Martin, Argenteuil (FR)

Correspondence Address: BROWDY AND NEIMARK, P.L.L.C.;624 NINTH STREET, NW, SUITE 300, WASHINGTON, DC, 20001-5303, US

(21) Appl. No.: 11/402,275

(22) Filed: Apr. 12, 2006

(30) Foreign Application Priority Data
Feb. 8, 2006 (FR) 06 01173

(51) Int. Cl. H04N 7/14

(52) U.S. Cl. 348/14.01

(57) ABSTRACT

The method according to the invention comprises the capture and storage of an image of a document by means of a camera optionally integrated into a communications terminal, with transfer of the image into the memory of the terminal, transmission of the image associated with complementary information by the terminal to a server, extraction, correction and optionally interpretation by the server of document-related information contained in the image, reconstruction of the document by means of extracted, corrected and optionally interpreted information and archiving of the document, taking into account information contained in the reconstructed document.

### BACKGROUND OF THE INVENTION

1. Field of the Invention

The present invention relates to a method for entering, archiving, consulting and transmitting a document to an addressee by means of a camera optionally integrated to a communications terminal, of a server and a terminal.

The method according to the invention is particularly adapted to a communications terminal fitted with a camera, but is also suitable for a camera having storage means which may be connected to a communications terminal.

This method is notably but not exclusively applied to capturing an image of a paper document or a document present on any other support or media (black or white board, paperboard, panel, and screen) by means of a camera optionally integrated into a communications terminal, to transmitting the image to a server, and then extracting, correcting, interpreting and archiving data contained in the image by the server, and finally to searching and consulting data archived on the server, and to transmitting them to an addressee or sharing them on a local or non-local communications network.

2. Description of the Prior Art

When it is desired to digitize a document in order to archive or transmit it to an addressee by fax or email, a piece of equipment dedicated to digitization of documents such as a scanner, a copy machine, or a fax machine must generally be used. Further, generally, one should simultaneously have a terminal connected to the acquisition device so as to be able to store the scan and optionally transmit it by email. This requires having both of these pieces of equipment available upon digitization, which is generally not the case when one is traveling away from the office. Further, if one only has a piece of equipment with which documents may be digitized, one is often limited by its memory, and there is a risk of loosing documents when the latter saturates or is faulty. When one uses a copy machine made available outside the office, the device might not well operate for lack of ink or paper, and photocopies are not simultaneously made available to other interested and remotely located persons.

Moreover, a wire or wireless connection with a network is required for transmitting the document to an addressee by fax, email, or Internet. Thus, when a document is transmitted to an addressee from a fax machine made available during traveling, the piece of equipment is tied up for an unspecified time and this until the fax machine prints the acknowledgement of receipt.

Moreover, it is common to try and utilize document images captured by means of a camera having fixed or removable storage means, and then transmitted to a terminal by connecting the latter to the aforesaid fixed or removable storage means of the camera. If the terminal integrates a software package for touching up images, one may then try to improve legibility of textual and graphical information relating to the document, by improving the balance of whites, adjusting the luminosity, enhancing the contours, intensifying the contrast, by improving saturation, attenuating noise, reframing the view of the document, turning over or inverting the image, correcting the perspective, chromatic aberration, optical distortion, blurring, or vignetting. These tedious operations for touching up images require sustained attention and significant know-how in the field of graphics, but they do not guarantee that a result is obtained close to that of a digitization of the document by means of a scanner. Additionally, one may try to interpret the information contained in the image with a character or graphic recognition software in order to re-utilize them, which facilitates search for information and reduces the size of the digitized information.

Finally, when it is desired to transmit a document in order to share it or to publish it on a local network such as an intranet, or on a non-local network such as an Internet site, a web log, or a site for sharing files or images, and when one does not have a scanner, one may take a picture of the document by means of a camera and transmit it over the network for sharing or publication by means of a communications terminal. However, the thereby shared or published textual and/or graphical information is often not very legible notably because of defects in the image of the document, related to the lack of contrast or to poor adjustment of the balance of whites.

### OBJECT OF THE INVENTION

The object of the present invention is notably to find a remedy to these drawbacks and to allow a document to be reconstructed by means of an image of the latter, and then its archiving, its consulting and its transmitting to an addressee.

### SUMMARY OF THE INVENTION

In this case the method according to the invention may involve:
A communications terminal TC;
A camera C with fixed or removable storage means which may be connected to the communications terminal or the camera being preferably connected and integrated to the communications terminal;
A server S fitted out with a central unit assembling together processing, storage and transmission means;
A terminal T fitted out with a central unit assembling processing, storage and transmission means, a keyboard and a display device;
An addressee DES having receiving means, such as a terminal, with means for receiving email, a fax, a server or a terminal, connected to a local network, such as an intranet or a non-local network such as Internet.

Thus, the method according to the invention comprises the following steps:
Capturing and storing an image of the document by means of the camera C;
If the camera is not connected to the communications terminal, connecting the fixed or removable memory of the camera to the communications terminal, and transferring the image into the memory of the communications terminal;
Transmitting the image of the document by the communications terminal TC to the server S, as well as optionally its addressee DES and/or its title and/or a comment;
Extracting, correcting, and optionally interpreting information relative to the document, contained in the image, by processing means integrated to the server S, and reconstructing it by means of the extracted, corrected, and optionally interpreted information;
Archiving the document on the server S, while taking into account the information contained in the reconstructed document as well as that concerning its history;
Optionally searching and/or consulting and/or modifying and/or suppressing information relative to an archived document on the server S from the terminal T, and/or from the communications terminal TC, and/or controlling its transmission to an addressee;
Optionally transmitting information relative to the reconstructed document or to its history, by the server S to the addressee DES and/or to the communications terminal TC, and/or to the terminal T.

### DESCRIPTION OF THE PREFERRED EMBODIMENTS

Advantageously, in the event of the server S having received the image of the document transmitted by the communications terminal TC, the server S will be able to transmit an acknowledgment of receipt message to the communications terminal TC.

Advantageously, the extraction and correction of textual and/or graphical information of the image of the document may be carried out by methods for extracting raw data from an image resulting from a shot, as already proposed by the applicant in application PCT/FR05/00678 which is incorporated by reference, and comprising the following steps:
determining for each point located by column C and line L of the image, a value V₀ [C, L] consisting in a combination of components of the color of the image,
calculating for each point of the image, a background value V_{Fond} [C, L],
calculating for each point of the image, the difference D [C, L],
D [C, L]=V_{Fond-V}₀ [C, L] (dark data/bright background),
or
V₀ [C, L]−V_{Fond} (bright data/dark background),
calculating a threshold value V_{S} consisting in a noise contextual datum used for correcting extracted raw data D [C, L], from at least one contrast histogram and/or from the probability q that a regional maximum of raw data contains noise,
correcting raw data D [C, L] by means of the noise contextual datum V_{S} resulting in the extracted data D* [C, L],
calculating for each point of the image, a corrected value I* [C, L] taking into account the corrected raw datum D* [C, L],
optionally presenting the extracted data or the image containing them under a desired angle.

The same method is characterized in that, in the case of presentation of data extracted from an image or from an image containing them according to a desired angle of view, from a picture taken with a camera under any incidence, it comprises:
searching for at least four identifiable characteristic points of a pattern present in the picture taken by the camera defining contextual data, these characteristic points may consist in the corners of the image,
optionally extracting data according to predetermined criteria,
calculating geometrical distortions to be made to the raw image or to the extracted data or to the image containing them, from the relative position of the four points, with respect to relative positions of references,
determining the corrections to be made to the raw image or to the extracted data or to the image containing them, according to the geometrical distortions,
generating a corrected image taking into account the thereby determined corrections.

The same method is also characterized in that in order to obtain a corrected image with the same proportions as the object, it comprises the determination of the actual height/width ratio of the quadrilateral defined by the aforesaid points and taking this ratio r into account in the generation of the corrected image.

Thus, correction of extracted textual and/or graphical information may concern the geometry, the color, the blurring and/or the contrast, and in a non-limiting way, enhancement of the balance of whites, adjustment of the luminosity and of the contrast, enhancement of the contours, intensification of the contrast, improvement of the saturation, attenuation of the noise, reframing of the view of the document, turning over or inverting the image, correcting perspective, chromatic aberration, optical distortion, blurring or vignetting.

Advantageously, archiving of the document by the server will comprise the following steps:
generating a reduced image of the reconstructed document;
generating index tables while taking into account the information relative to the document to be archived.

Advantageously, the information relative to a document contained in the reconstructed document as well as that concerning its history, may concern:
the file name of the image of the document;
the optional title and/or comment transmitted by the communications terminal or terminal T;
the location and/or the date and/or the time of the capture of the image of the document;
the date of transmission of the image of the document to the server;
the reconstruction status of the document;
the reconstruction date of the document;
the addressees, the dates, and the statuses of the transmissions of the document to these addressees;
textual information optionally interpreted by means of a character recognition software package;
graphic information possibly interpreted by a pattern recognition software package.

Advantageously, the result from the optional document information search from the terminal T or from the communications terminal TC may comprise the list of documents, for which the relative pieces of information are the ones searched for, optionally accompanied by some pieces of their relative information.

Advantageously, in the event that the quality of the resolution of the image of the document does not allow the extraction of textual or graphical information legible or interpretable by a character or pattern recognition software package, even after correction, the server S will be able to transmit a warning message to the terminal T and to the communications terminal TC, optionally accompanied by pieces of advice allowing the shooting of the document to be improved.

In the opposite case when textual and graphical information extracted from the image of the document, and then corrected, is deemed to be legible or interpretable by a character or pattern recognition software package, the server S will be able to transmit a warning message to the communications terminal TC or to the terminal T.

Advantageously, in the event of the server S having received an acknowledgment of receipt of the fax or email transmission of the digitized document to the addressee DES, the server S will be able to transmit an acknowledgment of receipt message to the communications terminal TC or to the terminal T.

Advantageously, transfer of the image or of information relative to the document will be performed via a wire connection such as the series or USB link or a wireless connection such as 802.11, Wimax, or Bluetooth, or a wired, switched, ADSL, communications network, or a cellular network such as GSM, GPRS or UMTS, or a local network such as an intranet, or a non-local network such as Internet.

1. A method for entering, archiving, consulting and transmitting a document to an addressee (DES) by means of a camera (C) optionally integrated to a communications terminal (TC), a server (S) or a terminal (T),
Said method comprising the following steps:
capturing and storing an image of the document by means of the camera (C);
if the camera (C) is not connected to the communications terminal (TC), connecting the fixed or removable memory of the camera (C) to the communications terminal (TC), and transferring the image into the memory of the communications terminal (TC);
transmitting the image of the document by the communications terminal (TC) to the server (S) as well as optionally its addressee (DES) and/or its title, and/or a comment;
extracting, correcting, and optionally interpreting with processing means integrated to the server (S), information relative to the document, contained in the image, and then reconstructing it by means of the extracted, corrected, and optionally interpreted information;
archiving the document on the server (S), while taking into account information contained in the reconstructed document as well as that concerning its history;
optionally searching and/or consulting and/or modifying and/or suppressing information relative to an archived document on the server (S) from the terminal (T) and/or from the communications terminal (TC) and/or ordering its transmission to an addressee (DES);
optionally transmitting information relative to the reconstructed document and/or to its history by the server (S) to the addressee (DES) and/or to the communications terminal (TC) and/or to the terminal (T).

2. The method according to claim 1 wherein, in the case when the server (S) receives the image of the document transmitted by the communications terminal (TC), the server (S) transmits an acknowledgment of receipt message to the communications terminal (TC).

3. The method according to claim 1, wherein the correction of information extracted from the image concerns the geometry, the color, the blurring and/or the contrast, or improvement of the balance of whites, or adjustment of the luminosity and contrast, or enhancement of the contours, or intensification of the contrast, or improvement of the saturation, or attenuation of the noise, or reframing the view of the document, or turning over or inverting the image, or correcting perspective, chromatic aberration, optical distortion, blurring or vignetting.

4. The method according to claim 1, wherein the archiving by the server (S) of the document comprises the following steps:
generating a reduced image of the reconstructed document;
generating index tables taking into account information relative to the document to be archived.

5. The method according to claim 1, wherein the result from the document information search comprises the list of documents for which the relative pieces of information are those searched for, optionally accompanied by some of their relative information.

6. The method according to claim 1, wherein the information relative to a document, contained in the reconstructed document as well as that concerning its history, comprises the file name of the image of the document, the title and/or comment optionally transmitted by the communications terminal (TC) or the terminal (T) to the server (S), the location and/or the date and/or the time of capture of the image of the document by the camera (C), the brand and/or the version of the camera (C), the date of transmission by the communications terminal (TC) of the image to the server (S), the state of reconstruction of the document, the reconstruction date of the document, the successive addressees of the document, the dates and the statuses of transmissions of the document to these addressees by the server (S), the textual information optionally interpreted by a character recognition software package, the graphic information, optionally interpreted by a pattern recognition software package.

7. The method according to claim 1 wherein, in the event that the quality of the resolution of the image of the document does not allow extraction of textual or graphical information legible or interpretable by a character or pattern recognition software package, even after correction, the server (S) transmits a warning message to the terminal (T) or to the communications terminal (TC), optionally accompanied by pieces of advice allowing the shooting of the document to be improved.

8. The method according to claim 1 wherein, in the case when the extracted textual or graphical information from the image of the document, and then corrected, is deemed to be legible or interpretable by a pattern or character recognition software package, the server (S) transmits a warning message to the communications terminal (TC) and/or to the terminal (T).

9. The method according to claim 1 wherein, in the event of the server (S) having received an acknowledgment of receipt of the fax or email transmission of the digitized document to the addressee (DES), the server (S) transmits an acknowledgment of receipt message to the communications terminal (TC) or to the terminal (T).
